(19) United States
(12) Patent Application Publication
(10) Pub. No.: US 2005/0058142 A1
(43) Pub. Date: Mar. 17, 2005

(54) Wireless router device for various system

(76) Inventors: Ching Hsiang Lee, Hsin Chuang City (TW); Wen Hsiang Tsai, Hsin Chuang City (TW); Hsiao Kai Wang, Hsin Chuang City (TW)

Correspondence Address: Ching Hsiang Lee, P.O. Box 4-67, Hsin Chuang, Taipei, 242, TW

(21) Appl. No.: 10/830,178

(22) Filed: Apr. 20, 2004

Related U.S. Application Data
(63) Continuation-in-part of application No. 10/662,646, filed on Sep. 12, 2003.
(63) Continuation-in-part of application No. 10/662,648, filed on Sep. 12, 2003.

(51) Int. Cl. H04Q 7/20

(52) U.S. Cl. 370/401; 455/401

(57) ABSTRACT

A wireless router device includes a wireless transmission circuit coupled to a processor unit, for communicating with various network systems. A coupler is coupled to the processor unit, a telecommunication card may be selectively plugged to the coupler to allow wireless transmission or telecommunication signals to be transmitted between the processor unit and telecommunication stations. A network device may be coupled to the processor unit, for communicating the processor unit with end users. The wireless router device may be coupled to various telecommunication systems, such as GPRS, PHS, CDMA, WAP, 3G, DECT, or UMTS systems, etc. via various cards.

The present invention is a continuation-in-part of U.S. patent application Ser. Nos. 10/662,646, and 10/662,648, both filed 12 Sep. 2003, pending.

### BACKGROUND OF THE INVENTION

1. Field of the Invention

The present invention relates to a router device, and more particularly to a wireless router device for wirelessly coupling to various wireless transmission systems, and for allowing end users to easily enter into local area network (LAN) and wireless local area network (WLAN) systems via the various wireless transmission systems.

2. Description of the Prior Art

Various kinds of typical wireless communication techniques have been developed and provided for allowing end users to view various network stations, to transmit information, to search for various information, to deal with the others, to teach people, to play video games, to transmit and receive electric mails, etc.

Accordingly, various kinds of typical wireless communication protocols or systems have been developed and provided for allowing end users to conduct various wireless transmission operations, such as wireless local area network (WLAN) system, general packet radio service (GPRS) system, personal handy phone system (PHS) system, code division multiple access (CDMA) system, wireless application protocol (WAP) system, third generation (3G) system, digital European cordless telecommunication (DECT) system, universal mobile telecommunication system (UMTS), etc.

The typical router devices that are used nowadays are required to set up a number of access points in many different positions or places, for allowing the end users to enter into various network systems. It will be easier to set up the access points in different positions or places in urban areas. However, it will be difficult to set up the access points in suburban areas or in backward areas or countries, such that the end users may not easily enter into various network systems in suburban areas.

The present invention has arisen to mitigate and/or obviate the afore-described disadvantages of the conventional wireless communication techniques or devices.

### SUMMARY OF THE INVENTION

The primary objective of the present invention is to provide a wireless router device for wirelessly coupling to, and for allowing end users to easily enter into various wireless network or communication systems, and to enjoy instant coupling or connection and high speed transmission effects.

The other objective of the present invention is to provide a wireless router device for allowing end users to easily select or chose either of the methods or systems, such as LAN, WLAN, WAP, GPRS, PHS, CDMA, UMTS, DECT, 3G, etc., for connecting or coupling to the network systems.

In accordance with one aspect of the invention, there is provided a wireless router device comprising a processor unit, a wireless transmission circuit coupled to the processor unit, for transmitting wireless signals to and from the processor unit, and for communicating with various network systems, a coupler coupled to the processor unit, a telecommunication card for selectively coupling to the coupler to allow wireless transmission or telecommunication signals to be transmitted between the processor unit and a telecommunication station, a network device coupled to the processor unit, for communicating the processor unit with end users. The wireless transmission circuit and the coupler and the network device are communicatable with each other via the processor unit, to allow end users to couple and share information from the network systems and the telecommunication station.

The wireless router device may be used for wirelessly coupling to various telecommunication systems, such as GPRS, PHS, CDMA, WAP, 3G, DECT, or UMTS systems, etc., and for allowing end users to easily enter into various wireless network or communication systems, and to enjoy instant coupling or connection and high speed transmission effects, and for allowing end users to easily select or chose either of the methods or systems, such as LAN, WLAN etc., for connecting or coupling to the network systems.

An antenna may further be provided and coupled to the wireless transmission circuit, for communicating the processor unit with the network systems. The network device includes a plurality of couplers for communicating with various end users. A second network device may further be provided and coupled to the processor unit, for communicating the processor unit with various network systems.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a wireless router device in accordance with the present invention;

FIG. 2 is a schematic view illustrating the operation of the wireless router device for coupling or communicating with a GPRS system;

FIG. 3 is a schematic view similar to FIG. 2, illustrating the operation of the wireless router device for communicating or coupling with ethernet or other network systems; and

FIG. 4 is a plan schematic view similar to FIG. 1, illustrating a simplified module or arrangement of the wireless router device.

### DETAILED DESCRIPTION OF THE PREFERRED EMBODIMENT

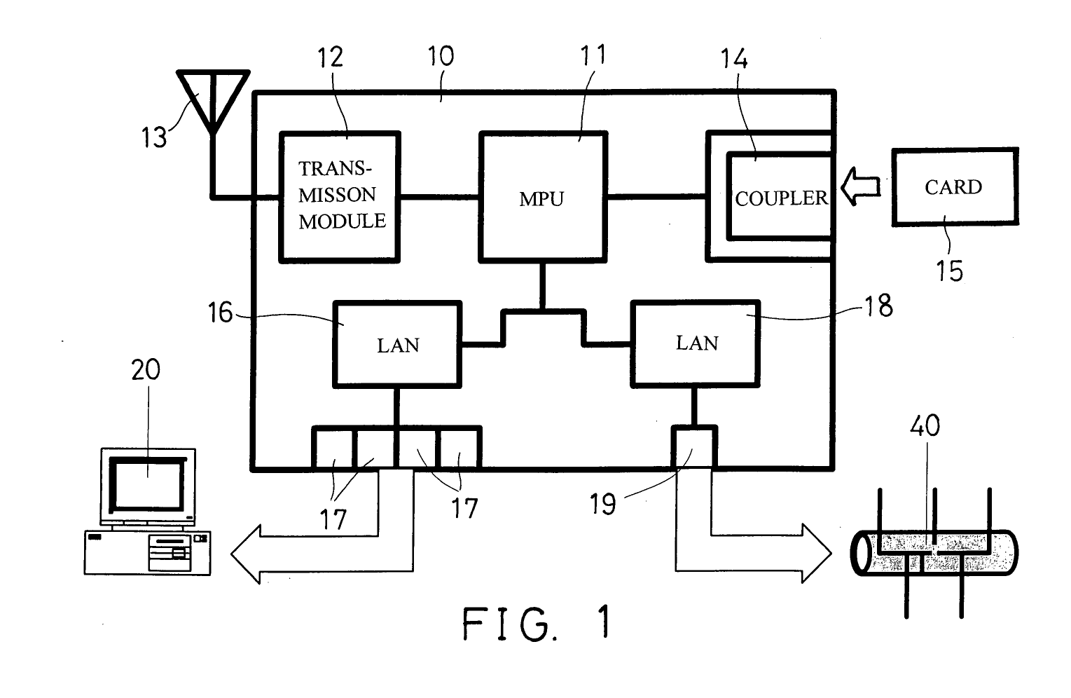

Referring to the drawings, and initially to FIG. 1, a wireless router device 10 in accordance with the present invention comprises a processor unit or microprocessor device (MPU) 11, a transmission module, such as a wireless transmission module or circuit 12 coupled to the MPU 11 and coupled to an antenna 13, for transmitting package information or wireless signals between the MPU 11 and the antenna 13, and thus for allowing the router device 10 to be communicated with various network systems.

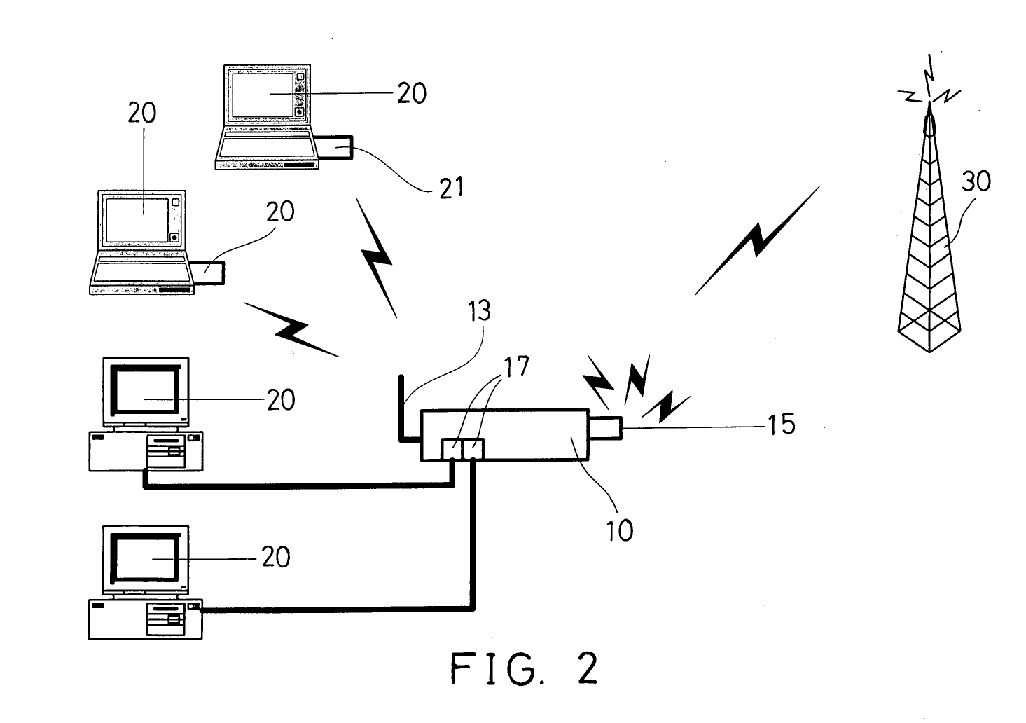

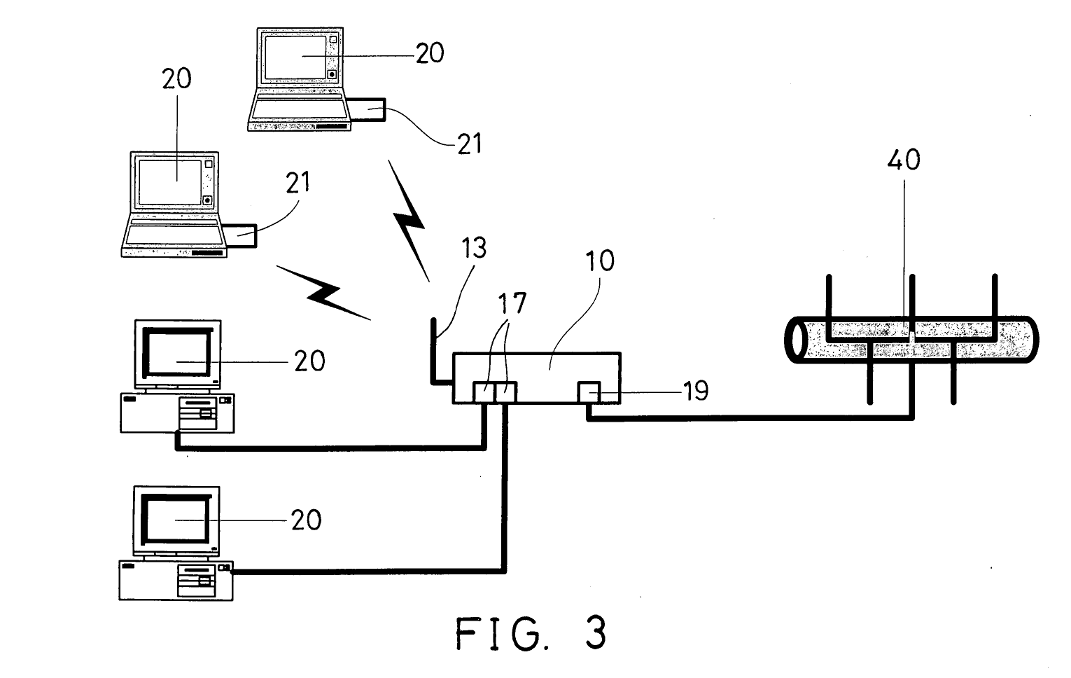

The antenna 13 is provided for transmitting and receiving package information or wireless signals that accord with the WLAN telecommunication protocol, such as the signals of institute of electrical and electronic engineers (IEEE) 802.11b, 802.11a, or 802.11g, etc. The end users 20 may be communicated with the router device 10 with wireless interface or card devices 21, as shown in FIGS. 2 and 3.

In operation, the wireless transmission module or circuit 12 may be used for converting the package information or signals from the MPU 11 into wireless signals, and for providing the wireless signals to the antenna 13, and thus for allowing the wireless signals to be transmitted to the end users 20 or various network systems or controllers via the antenna 13.

On the contrary, the wireless transmission module or circuit 12 may also be used for converting the wireless signals from the antenna 13 into the package information or signals, and for providing the package information or signals to the MPU 11, and thus for allowing the wireless signals to be converted to the package information or signals and to be treated or processed by the MPU 11.

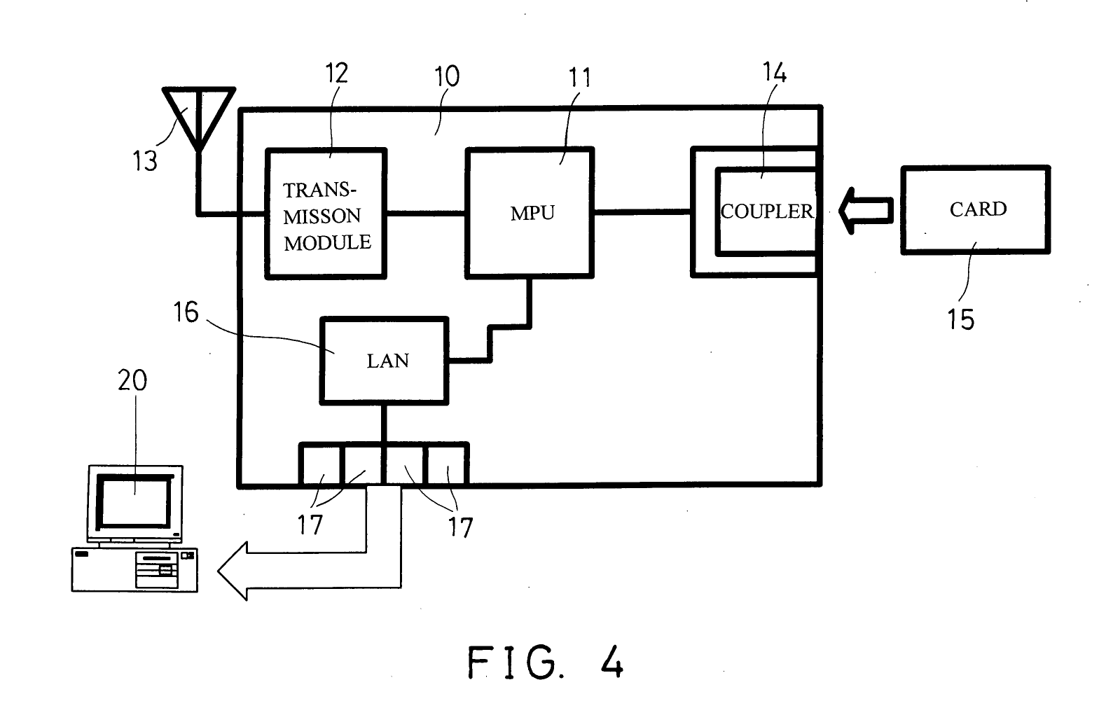

As shown in FIGS. 1 and 4, the router device 10 further includes an interface or socket or coupler 14 coupled to the MPU 11, for coupling or plugging a card 15, such as a wireless transmission or telecommunication card 15, in which the interface or socket or coupler 14 may be a card bus interface, a personal computer memory card international association (PCMCIA) interface, or the like, for allowing various telecommunication cards 15 to couple to the interface or socket or coupler 14 selectively or changeably.

The wireless transmission or telecommunication cards 15 may be selected from various wireless telecommunication or transmission operations or systems, such as general packet radio service (GPRS) card, personal handy phone system (PHS) card, code division multiple access (CDMA) card, wireless application protocol (WAP) card, third generation (3G) card, digital European cordless telecommunication (DECT) card, universal mobile telecommunication card (UMTS), etc., for transmitting package information or wireless signals purposes, and thus for allowing the router device 10 to be communicated with various network or telecommunication systems.

In operation, either of the cards 15, such as GPRS, PHS, CDMA, WAP, 3G, DECT, UMTS card 15 may be selectively coupled or plugged to the coupler 14, for allowing wireless transmission or telecommunication signals to be selectively transmitted to and received from the GPRS, PHS, CDMA, WAP, 3G, DECT, or UMTS systems or stations 30.

The router device 10 further includes an LAN chip or device 16 coupled to the MPU 11. The LAN or network device 16 includes one or more ports or couplers 17 for coupling to various end users 20 (FIGS. 1-4), and for allowing various end users 20 to be communicated with various network systems via the router device 10, and for allowing various end users 20 to share the information or system or service from the GPRS, PHS, CDMA, WAP, 3G, DECT, or UMTS systems or stations 30.

As shown in FIGS. 1 and 3, the router device 10 may further include an additional network chip or device 18 coupled to the MPU 11. The network device 18 includes a port or coupler 19 for coupling to various network systems, such as ethernet systems 40. The router device 10 also be arranged without the network device 18, as shown in FIG. 4, but may also be coupled to the GPRS, PHS, CDMA, WAP, 3G, DECT, or UMTS systems or stations 30, and to obtain the information or services from the GPRS, PHS, CDMA, WAP, 3G, DECT, or UMTS systems or stations 30.

Accordingly, the wireless router device in accordance with the present invention may be used for wirelessly coupling to GPRS, PHS, CDMA, WAP, 3G, DECT, or UMTS systems, and for allowing end users to easily enter into various wireless network or communication systems, and to enjoy instant coupling or connection and high speed transmission effects, and for allowing end users to easily select or chose either of the methods or systems, such as LAN, WLAN etc., for connecting or coupling to the network systems.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A wireless router device comprising:
a processor unit,
a wireless transmission circuit coupled to said processor unit, for transmitting wireless signals to and from said processor unit, and for communicating with various network systems,
a coupler coupled to said processor unit,
a telecommunication card for selectively coupling to said coupler to allow wireless transmission or telecommunication signals to be transmitted between said processor unit and a telecommunication station,
a network device coupled to said processor unit, for communicating said processor unit with end users,
said wireless transmission circuit and said coupler and said network device being communicatable with each other via said processor unit, to allow end users to couple and share information from the network systems and the telecommunication station.

2. The wireless router device as claimed in claim 1 further comprising an antenna coupled to said wireless transmission circuit, for communicating said processor unit with the network systems.

3. The wireless router device as claimed in claim 1, wherein said network device includes a plurality of couplers for communicating with various end users.

4. The wireless router device as claimed in claim 1 further comprising a second network device coupled to said processor unit, for communicating said processor unit with various network systems.
